(19) United States
(12) Patent Application Publication
(10) Pub. No.: US 2019/0047325 A1
(43) Pub. Date: Feb. 14, 2019

(54) Graft Copolymers for Dispersing Graphene and Graphite

(71) Applicant: ExxonMobil Chemical Patents Inc., Baytown, TX (US)

(72) Inventors: Andy H. Tsou, Houston, TX (US); Hillary L. Passino, Houston, TX (US); Yong Yang, Kingwood, TX (US)

(21) Appl. No.: 16/075,815

(22) PCT Filed: Apr. 19, 2017
(86) PCT No.: PCT/US2017/028290

§ 371 Date: Aug. 6, 2018

Related U.S. Application Data
(60) Provisional application No. 62/356,248, filed on Jun. 29, 2016.

(30) Foreign Application Priority Data
Aug. 23, 2016 (EP) 16185358.5

(51) Int. Cl. B60C 1/00; C08L 23/28; C08K 3/013; C08K 3/04; C08K 3/34; C08L 23/16; C08L 23/18

(52) U.S. Cl. CPC B60C 1/0008; C08L 23/283; C08K 3/013; C08L 23/18; C08K 3/346; C08L 23/16; C08K 3/04

(57) ABSTRACT

Disclosed herein are graft copolymer nanofiller dispersants comprising a polyaromatic hydrocarbon backbone and polyaliphatic hydrocarbon comb arms and methods for making same. Also disclosed are elastomeric nanocomposite compositions comprising a halobutyl rubber matrix nanoparticles of graphite or graphene, and the graft copolymer nanofiller dispersant. Such elastomeric nanocomposite compositions are useful tire innerliners or innertubes.

### PRIORITY CLAIM

This application claims priority to U.S. Provisional Application Ser. No. 62/356,248 filed Jun. 29, 2016 and European Application No. 16185358.5 filed Aug. 23, 2016, the disclosures of which are fully incorporated herein by their reference.

### FIELD OF THE INVENTION

The present invention relates to graft copolymers having a polyaromatic hydrocarbon backbone and polyaliphatic hydrocarbon branches for use as a graphite or to graphene dispersant in elastomeric nanocomposite compositions.

### BACKGROUND OF THE INVENTION

Halobutyl rubbers, which are halogenated isobutylene/isoprene copolymers, are the polymers of choice for best air retention in tires for passenger, truck, bus, and aircraft vehicles. Bromobutyl rubber, chlorobutyl rubber, and halogenated star-branched butyl rubbers can be formulated for specific tire applications, such as tubes or innerliners. The selection of ingredients and additives for the final commercial formulation depends upon the balance of the properties desired, namely, processability and tack of the green (uncured) compound in the tire plant versus the in-service performance of the cured tire composite. Examples of halobutyl rubbers are bromobutyl (brominated isobutylene-isoprene rubber or BIIR), chlorobutyl (chlorinated isobutylene-isoprene rubber or CIIR), star-branched butyl (SBB), EXXPRO™ elastomers (brominated isobutylene-co-p-methyl-styrene) copolymer or BIMS), etc.

For rubber compounding applications, traditional small sub-micron fillers such as carbon black and silica are added to halobutyl rubbers to improve fatigue resistance, fracture toughness and tensile strength. More recently, methods to alter product properties and improve air barrier properties in halobutyl rubbers have been developed that comprise adding nanofillers apart from than these traditional fillers to the elastomer to form a “nanocomposite.” Nanocomposites are polymer systems containing inorganic particles with at least one dimension in the nanometer range (see for example WO Publication No. 2008/042025).

Common types of inorganic particles used in nanocomposites are phyllosilicates, an inorganic substance from the general class of so called “nanoclays” or “clays” generally provided in an intercalated form wherein platelets or leaves of the clay are arranged in a stack in the individual clay articles with interleaf spacing usually maintained by the insertion of another compound or chemical species between the adjacent lamellae. Ideally, intercalation inserts into the space or gallery between the clay surfaces. Ultimately, it is desirable to have exfoliation, wherein the polymer is fully dispersed with the individual nanometer-size clay platelets.

The extents of dispersion, exfoliation, and orientation of platy nanofillers such as organosilicates, mica, hydrotalcite, graphitic carbon, etc., strongly influence the permeability of the resulting polymer nanocomposites. The barrier property of a polymer in theory is significantly improved, by an order of magnitude, with the dispersion of just a few volume percent of exfoliated high aspect-ratio platy fillers, due simply to the increased diffusion path lengths resulting from long detours around the platelets. Nielsen, J. Macromol. Sci. (Chem.), vol. A1, p. 929 (1967), discloses a simple model to determine the reduction in permeability in a polymer by accounting for the increase in tortuosity from impenetrable, planarly oriented platy fillers. Gusev et al., Adv. Mater., vol. 13, p. 1641 (2001), discloses a simple stretched exponential function relating the reduction of permeability to aspect ratio times volume fraction of the platy filler that correlates well with permeability values numerically simulated by direct three-dimensional finite element permeability calculations.

To maximize the effect of aspect ratio on permeability reduction, it is therefore useful to maximize the degree of exfoliation and dispersion of the platelets, which are generally supplied in the form of an intercalated stack of the platelets. However, in isobutylene polymers, dispersion and exfoliation of platy nanofillers require sufficient favorable enthalpic contributions to overcome entropic penalties. As a practical matter, it has thus proven to be very difficult to disperse ionic nanofillers such as clay into generally inert, nonpolar, hydrocarbon elastomers. The prior art has, with limited success, attempted to improve dispersion by modification of the clay particles, by modification of the rubbery polymers, by the use of dispersion aids, and by the use of various blending processes.

Due to the difficulties encountered in dispersing ionic nanoclays in nonpolar elastomers, graphitic carbon has been explored as an alternative platy nanofiller. For example, elastomeric compositions comprising graphite nanoparticles are described in U.S. Pat. No. 7,923,491.

U.S. Publication No. 2006-0229404 discloses a method for making compositions of an elastomer with exfoliated graphite in which the diene monomers are polymerized in the presence of 10 phr or more exfoliated graphite so that the graphite is intercalated with the elastomer. U.S. Pat. No. 8,110,026 describes a process for producing a functional graphene sheet (FGS) based on exfoliation of oxidized graphite suitable for a high degree of dispersion in a polymer matrix for use in a nanocomposite.

Nano graphene platelets (NGPs) obtained through rapid expansion of graphite have become commercially available as of late. These NGPs have graphitic surfaces, as opposed to graphene oxide platelets of oxidized graphitic surfaces, and are quite compatible with hydrocarbon based non-polar butyl halobutyl rubbers. However, a high degree of exfoliation and dispersion of NGPs without agglomerations and aggregations cannot be achieved by solid compounding or solution mixing of these nanoparticles into halobutyl rubbers.

Other references of interest include WO Publication No. 2015/076878.

U.S. Provisional Application No. 62/235,116 filed on Sep. 30, 2015 discloses polycyclic aromatic hydrocarbon functionalized isobutylene copolymers and the use of these copolymers as a nanofiller dispersant to improve the degree of NGP dispersion. There remains a need, however, for improving the dispersion of graphite and graphene nanofillers in elastomeric nanocomposite compositions comprising halobutyl rubbers useful for tires, air barriers, among other things requiring air retention, in order to improve the air impermeability of those compositions.

### SUMMARY OF THE INVENTION

The present invention fulfills the need for improved dispersion of graphite and graphene nanofillers in elastomeric nanocomposite compositions by providing a graphite and graphene nanofiller dispersant useful in isobutylene-based elastomer/nanofiller nanocomposite compositions that results in these nanocomposite compositions having improved air barrier properties and that are suitable for use as a tire innerliner or innertube. Generally, the nanofiller dispersant comprises the reaction product of a polyaromatic hydrocarbon and a polyaliphatic hydrocarbon, ideally vinyl/vinylidene-terminated polyisobutylene.

The invention further relates to methods for producing these nanofiller dispersant compositions and elastomeric nanocomposite compositions comprising the produced nanofiller dispersant. Preferably, the nanofiller dispersant compositions are produced by combining at least one polyaromatic hydrocarbon and at least one polyaliphatic hydrocarbon with a Friedel-Crafts catalyst at a temperature within the range from 80° C. to 200° C. Preferably, an elastomeric nanocomposite comprising the nanofiller dispersant is produced by blending the nanofiller dispersant with (i) at least one halogenated elastomer component comprising units derived from isoolefins having from 4 to 7 carbons, preferably wherein the elastomer component comprises units derived from at least one multiolefin and (ii) at least one nanofiller.

### DETAILED DESCRIPTION OF THE INVENTION

This invention describes graft copolymers having a polyaromatic hydrocarbon backbone with polyaliphatic hydrocarbon branches, ideally polyisobutylene, useful as a nanofiller dispersant in isobutylene-based elastomer/nanofiller nanocomposite compositions. The nanocomposite composition can include a halogenated isobutylene-based elastomer and a nanofiller, desirably either graphite or graphene, suitable for use as an air barrier. The nanocomposite composition formed of this invention has improved air barrier properties and is suitable for use as an innerliner or innertube.

### Definitions

As used herein, “polymer” may be used to refer to homopolymers, copolymers, interpolymers, terpolymers, etc. Likewise, a copolymer may refer to a polymer comprising at least two monomers, optionally with other monomers. As used herein, when a polymer is referred to as “comprising” a monomer, the monomer is present in the polymer in the polymerized form of the monomer or in the derivative form the monomer. Likewise, when catalyst components are described as comprising neutral stable forms of the components, it is well understood by one skilled in the art, that the ionic form of the component is the form that reacts with the monomers to produce polymers.

As used herein, “elastomer” or “elastomeric composition” refers to any polymer or composition of polymers (such as blends of polymers) consistent with the ASTM D1566 definition. Elastomer includes mixed blends of polymers such as melt mixing and/or reactor blends of polymers. The terms may be used interchangeably with the term “rubber.”

As used herein, “nanoparticle” or “nanofiller” refers to an inorganic particle with at least one dimension (length, width, or thickness) of less than 100 nanometers.

As used herein, “elastomeric nanocomposite” or “elastomeric nanocomposite composition” refers to any elastomer or elastomeric composition further comprising nanofiller and, optionally, a thermoplastic resin.

As used herein, “phr” is ‘parts per hundred rubber’ and is a measure common in the art wherein components of a composition are measured relative to a major elastomer component, based upon 100 parts by weight of the elastomer(s) or rubber(s).

As used herein, “compounding” refers to combining an elastomeric nanocomposite composition with other ingredients apart from nanofiller and thermoplastic resin. These ingredients may include additional fillers, curing agents, processing aids, accelerators, etc.

As used herein, “isobutylene based elastomer” or “isobutylene based polymer” or “isobutylene based rubber” refers to elastomers or polymers comprising at least 70 mole percent isobutylene.

As used herein, “isoolefin” refers to any olefin monomer having at least one olefinic carbon having two substitutions on that carbon.

As used herein, “multiolefin” refers to any monomer having two or more double bonds, for example, a multiolefin may be any monomer comprising two conjugated double bonds, such as a conjugated diene such as isoprene.

As used herein, “exfoliation” refers to the separation of individual layers of the original inorganic particle, so that polymer can surround or surrounds each separated particle. In an embodiment, sufficient polymer or other material is present between each platelet such that the platelets are randomly spaced. For example some indication of exfoliation or intercalation may be a plot showing no X-ray lines or larger d-spacing because of the random spacing or increased separation of layered platelets. However, as recognized in the industry and by academia, other indicia may be useful to indicate the results of exfoliation such as permeability testing, electron microscopy, atomic force microscopy, etc.

The term “aspect ratio” is understood to mean the ratio of the larger dimension of the leaves or platelets of nanofiller, to the thickness of the individual leaf or of the agglomerate or stack of leaves or platelets. The thickness of the individual leaf/platelet can be determined by crystallographic analysis techniques, whereas the larger dimension of a leaf/platelet are generally determined by analysis by transmission electron microscopy (TEM), both of which are known in the art.

As used herein, “solvent” refers to any substance capable of dissolving another substance. When the term solvent is used, it may refer to at least one solvent or two or more solvents unless specified. The solvent can be polar. Alternatively, the solvent can be non-polar.

As used herein, “solution” refers to a uniformly dispersed mixture at the molecular level or ionic level, of one or more substances (solute) in one or more substances (solvent). For example, solution process refers to a mixing process that both the elastomer and the modified layered filler remain in the same organic solvent or solvent mixtures.

As used herein, “hydrocarbon” refers to molecules or segments of molecules containing primarily hydrogen and carbon atoms. Often, hydrocarbon also includes halogenated versions of hydrocarbons and versions containing heteroatoms as discussed in more detail below.

As used herein, “polyaromatic hydrocarbon” refers to a hydrocarbon polymer containing multiple aromatic rings.

As used herein, “polyaliphatic hydrocarbon” refers to a non-aromatic hydrocarbon polymer.

As used herein, the term “Friedel-Crafts alkylation reaction” refers to both those reactions defined as Friedel-Crafts alkylation reactions and those that mimic the behavior of Friedel-Crafts alkylation reactions. As used herein, the term “Friedel-Crafts catalyst” refers to compounds capable of catalyzing a Friedel-Crafts alkylation reaction, e.g., Lewis acids.

### Graft Copolymer Nanofiller Dispersant

The graft copolymer nanofiller dispersants of this invention comprise a polyaromatic hydrocarbon backbone and polyaliphatic hydrocarbon branches. Generally, the graft copolymers are the reaction product between a polyaromatic hydrocarbon and a polyaliphatic hydrocarbon, ideally vinyl/vinylidene-terminated polyisobutylene. The resulting graft copolymers are useful for dispersing graphite or graphene nanoparticles in a halobutyl matrix based elastomeric nanocomposite. Without wishing to be bound by theory, it is believed that the graft copolymers herein operate as a graphite or graphene nanofiller dispersant by preferentially attaching to graphite or graphene surfaces through phi-phi* interaction between the aromatic rings of the polyaromatic hydrocarbon and the graphitic surface of the graphite or graphene nanoparticles, and that the dispersant effect of the copolymers is further enhanced via the polyaliphatic hydrocarbon branches extending away from the polyaromatic hydrocarbon backbone acting as brushes.

Generally, the graft copolymers comprise (or consist essentially of, or consist of) polyaliphatic and polyaromatic hydrocarbon components, wherein the polyaromatic hydrocarbon component is a polymer comprising heteroatoms or heteroatom containing moieties in its backbone and phenyl or substituted phenyl groups, the polyaliphatic hydrocarbon component covalently bound to the polyaromatic hydrocarbon component.

Preferably, the graft copolymers have the structure:

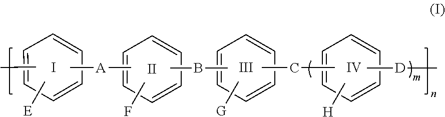

wherein each of I, II, III and IV are, independently, 1,2-phenyl, 1,3-phenyl or 1,4-phenyl, any of which may be substituted with one or more electron-donating substituents;
at least one of A, B, C, and D are, independently, an oxygen, nitrogen, sulfur, or phosphorous

atom, or a moiety comprising oxygen, nitrogen, sulfur, phosphorous, or a combination thereof;

at least one of E, F, G, and H are one, two or three polyaliphatic hydrocarbon components bound to I, II, III, and IV, respectively, and having a weight average molecular weight of at least 300 g/mole;

and

m is an integer within the range from 1 to 10, and n is an integer within the range from 10 to 500.

Most preferably, the polyaromatic hydrocarbon backbone is a poly(phenylene ether) (“PPE”) wherein in structure (I) each of A, B, C, and D is oxygen, and I, II, III and IV are 2,6-dimethyl-1,4-phenyl, and m is 1. Preferably, the polyaliphatic hydrocarbon is a vinyl/vinylidene-terminated polyolefin (“VTPO”), ideally vinyl/vinylidene polyisobutylene (“VTPIB”). For the graft copolymer in general, and a PPE-VTPO copolymer in particular, the branching index, g_{vis.avg}, is less than 0.95 or 0.90 or 0.85. The number average molecular weight (Mₙ) of the graft copolymer is preferably within a range of from 10,000 or 12,000 or 15,000 g/mole to 100,000 or 140,000 or 180,000 or 200,000 g/mole; and preferably the weight average molecular weight (M_{w}) is within a range from 15,000 or 20,000 g/mole to 200,000 or 250,000 or 300,000 or 350,000 g/mole. Also, the z-average molecular weight (M_{z}) of the graft copolymer, in general and for a PPE-VTPO copolymer, is within a range from 30,000 or 35,000 to 200,000 or 300,000 or 350,000 g/mole to 400,000 or 450,000 or 500,000 or 550,000 or 600,000 g/mole. These ranges apply to both LS or DRI GPC analysis of the copolymer. Preferably, the molar ratio of the polyaliphatic hydrocarbon to the polyaromatic hydrocarbon in the graft copolymer is within a range of from 99:1 or 90:10 to 50:50.

The synthesis of the graft copolymers generally utilizes mild catalytic Friedel-Crafts alkylation reactions. It has been found that polyaliphatic hydrocarbons, particularly unsaturated polyolefins, more specifically VTPOs, can be easily grafted onto the polyaromatic hydrocarbon backbone. Specifically, the vinyl/vinylidene end group of VTPO is a good precursor for carbocation, which acts as an electrophile, under a Brφnsted or Lewis acid catalyst. In addition, the arene groups of the polyaromatic hydrocarbon act as nucleophiles in the Friedel-Crafts reactions.

The preparation of the graft copolymers by the Friedel-Crafts reaction between a polyaromatic hydrocarbon and a polyaliphatic hydrocarbon will now be described in more detail. The invention is not limited to these aspects, and this description is not meant to foreclose other aspects within the broader scope of the invention, for example, where the graft copolymers are prepared through an alternative transformation route.

### Polyaromatic Hydrocarbon

Suitable polyaromatic hydrocarbons are preferred to have one or more aromatic moieties in the polymer repeating unit, or monomer, that are capable of undergoing Friedel-Crafts alkylation reactions. The polyaromatic hydrocarbons can be, but are not limited to aromatic polyamides, aromatic polyimides, aromatic poly(amide imide)s, aromatic polycarbonates, aromatic polyesters, poly(ether ether ketone)s, poly(ether ketone ketone)s, aromatic polysulfones, poly(phenylene ether)s, poly(phenylene sulfide)s, and polyxylylenes, but most preferably poly(phenylene ether)s.

The polyaromatic hydrocarbon exemplified herein is PPE. It is expected that the disclosed methods can be extended to polyaromatic hydrocarbons beyond PPE that share the following generalized chemical structure (II):

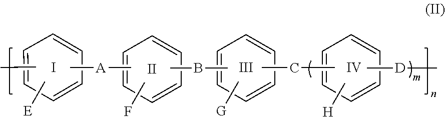

wherein each of I, II, III and IV in (I) are, independently, 1,2-phenyl, 1,3-phenyl or 1,4-phenyl, any of which may be substituted with one or more electron-donating substituents;

at least one of A, B, C, and D are, independently, an oxygen, nitrogen, sulfur, or phosphorous atom, or a moiety comprising oxygen, nitrogen, sulfur, phosphorous, or a combination thereof;

each of E, F, G, and H represent hydrogen atoms or C₁ to C₁₀ alkyls, or C₆ to C₁₂ aryls, and heteroatom substituted version thereof (e.g., amines, mercaptans, sulfonates, hydroxyl, carboxy, etc.); and

m is an integer within the range from 1 to 10, and n is an integer within the range from 10 to 500.

Preferably, the electron-donating substituents are selected from the group consisting of C₁ to C₁₀ alkyls, C₁ to C₁₀ alkoxys, C₁ to C₁₀ mercaptans, chlorine, bromine, iodine, hydroxyl, and combinations thereof. Also, more preferably, the A, B, C, and D substituents are selected from the group consisting of C₁ to C₁₀ carboxy-containing moieties, C₁ to C₁₀ imido-containing moieties, C₁ to C₁₀ sulfido-containing moieties, sulfur, sulfide, carboxy, carboxylate, imido, nitrogen, and combinations thereof. Even more preferably, the A, B, C, and D substituents are selected from the group consisting of —CH₂—NH—CO—(CH₂)₄—CH₂—, —OCOO—, CO—, pyromellitic diimidos, —SO₂—, sulfur, oxygen, nitrogen, phosphorous, and combinations thereof. Polyaromatic hydrocarbons useful herein (either as a reactant in the graft reaction or as the component of the copolymer) preferably, have a weight average molecular weight (M_{w}) within a range from 5,000 or 10,000 or 15,000 g/mole to 20,000 or 30,000 or 50,000 or 80,000 g/mole. Most preferably in structure (II) above, A, B, C, and D is oxygen, and I, II, III, and IV are 2,6-dimethyl-1,4-phenyl, and m is 1.

Specific examples of suitable polyaromatic hydrocarbons include, but are not limited to:
Nylon MXD6 (Reny™, Mitsubishi Gas Chemical), when I=II=III=IV=1,3-phenyl, m=1, A=B=C=D=—CH₂—NH—CO—(CH₂)₄—CH₂—.
PC (Lexan™, SABIC Innovative Plastics, Makrolona™, Bayer, Calibre™, Dow, Panlitem™, Teijin, Iupilona™, Mitsubishi, Xantar™, DSM), when I=II=III=IV=1,4-phenyl, m=1, A=C=—C(CH₃)₂—, B=D=—OCOO—.
PEEK (Victrex™, Victrex Plc, APC™, Cytec), when I=II=III=1,4-phenyl, m=0, A=B=—O—, C=—CO—.
Polyimide, e.g., Poly(pyromellitimide-1,4-diphenyl ether) (Kapton™, Vesper™, Pyralux™, Pyralin™, Interra™, DuPont), when I=II=III=IV=1,4-phenyl, m=1, A=C=—O—, B=D=pyromellitic diimido.
Bisphenol-A Polysulfone (Udel™, Solvay), when I=II=III=IV=1,4-phenyl, m=1, A=—C(CH₃)₂—, B=D=—O—, C=—SO₂—.
PPE, e.g., Poly(2,6-dimethyl-1,4-phenylene oxide) (PPO™, Noryl™, Noryl GTX™, Prevex™, Sabic Innovative Plastics, Xyron™, Ashahi Chemical, Iupiace™, Lemalloy™, Mitsubishi Engineering Plastics, Artley™, Sumitomo Chemical Co., Ltd., Blue Star™, Blue Star), when I=II=III=IV=2,6-dimethyl-1,4-phenyl, m=1, A=B=C=D=—O—.
PPS (Ryton™, Chevron Phillips Chemical, Fortron™, Celanese, Torelina™, Toray), when I=II=III=IV=1,4-phenyl, m=1, A=B=C=D=−5-.
Poly(p-xylylene) (Parylene™, formerly Union Carbide), when I=II=III=IV=1,4-phenyl, m=1, A=B=C=D=—CH₂CH₂—.

### Polyaliphatic Hydrocarbon

The polyaliphatic hydrocarbon may be either crystalline or amorphous, preferably amorphous. Suitable crystalline or amorphous polyaliphatic hydrocarbons, include but are not limited to polyethylene, polypropylene (isotactic, syndiotactic, or atactic), ethylene-propylene, ethylene-butene, ethylene-hexene, ethylene-octene copolymers, propylene-butene, propylene-hexene, propylene-octene copolymers, α-olefin homopolymers and copolymers, cyclic olefin homopolymers and copolymers, polydiene, polyisobutylene (“PIB”), and combinations thereof.

Suitable polyaliphatic hydrocarbons are preferred to be polyolefins having one or more unsaturations, more preferably at the chain ends. More specifically, preferred polyaliphatic hydrocarbons are VTPOs. The VTPOs can be made by any suitable means. Preferably, vinyl/vinylidene-terminated polyalphaolefins are made using conventional slurry or solution polymerization processes using a combination of bridged metallocene catalyst compounds (especially bridged bis-indenyl or bridged 4-substituted bis-indenyl metallocenes) with a high-molecular volume (at least a total volume of 1000 Å3) perfluorinated boron activator, for example as described in U.S. Publication No. 2012-0245299. Alternatively, vinyl/vinylidene-terminated polyisobutylene is preferably made using conventional solution cationic polymerization processes known in the art. Preferably, such cationic polymerization processes are initiated using a strong acid or a Lewis acid in combination with a co-initiator, e.g., AlCl₃ with HCl.

Suitable VTPOs can be any polyolefin having a vinyl/vinylidene-terminal group, as described above, any of which may have a number average molecular weight (Mₙ) of at least 300 g/mole. Preferably, greater than 80 or 85 or 90% of the polyolefin comprises terminal vinyl or vinylidene groups; or within the range of from 50 or 60 wt % to 70 or 80 or 90. As described above, the VTPOs preferably have a Mₙ within the range of from 200 or 400 or 500 g/mole to 20,000 or 30,000 or 40,000 or 50,000 or 100,000 or 200,000 or 300,000 g/mole. The VTPOs preferably have a weight average molecular weight (M_{w}) value within the range of from 500 or 800 or 1000 or 2000 g/mole to 6,000 or 10,000 or 12,000 or 20,000 or 30,000 or 40,000 or 50,000 or 100,000 or 200,000 or 300,000 g/mole. Preferably, the VTPO useful herein is amorphous polyisobutylene, and desirably has a glass transition temperature (Tg) of less than 10 or 5 or 0° C., more preferably, less than −30° C.; or within the range of from 0 or −5 or −10° C. to −50 or −60 or −70° C. or as described herein.

A particularly preferred VTPO is one wherein the vinyl/vinylidene-terminated polyolefin is vinylidene-terminated polyisobutylene, as represented by the formula (III):

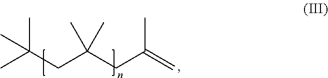

wherein n is an integer from 2 or 4 or 10 or 20 to 50 or 100 or 200 or 500 or 800.

### Friedel-Crafts Alkylation

A graft copolymer of the preferred composition can be synthesized by Friedel-Crafts alkylation of selective aromatic moieties of the polyaromatic hydrocarbon with polyaliphatic hydrocarbons with unsaturations, in a solution or solid state (such as in extruder) reaction. Compositionally, it is preferred to have the polyaliphatic hydrocarbon molar % in the resulting graft copolymers be greater than 50 mole %, more preferably greater than 55 mole %, and most preferably greater than 60 mole %.

The reaction between the polyaromatic hydrocarbon and polyaliphatic hydrocarbon is facilitated with a Friedel-Crafts catalyst at a temperature within the range from 80° C. or 100° C. to 140° C. or 160° C. or 180° C. or 200° C. Preferably, the polyaromatic hydrocarbon and polyaliphatic hydrocarbon are reacted in solution. Suitable solvents include high boiling saturated aliphatic hydrocarbons (C₈ to C₂₀), halogenated aliphatic hydrocarbons (C₁ to C₈), aryl hydrocarbons (C₆ to C₂₀), and halogenated aryl hydrocarbons (C₆ to C₂₀). Particularly preferred solvents include dodecane, toluene, xylenes, and ortho-dichloro benzene (oDCB).

### Elastomeric Nanocomposite

The uncompounded elastomeric nanocomposite composition can include up to 49 wt % of the graft copolymer nanofiller dispersant (i.e., based on the total weight of the nanofiller dispersant, elastomer component, and nanofiller). The uncompounded elastomeric nanocomposite composition can contain from 0.5 to 49 wt % of the graft copolymer nanofiller dispersant. Preferably, the uncompounded elastomeric nanocomposite composition contains from 2 to 49 wt % of the graft copolymer nanofiller dispersant. More preferably, the uncompounded elastomeric nanocomposite composition contains from 5 to 45 wt % of the graft copolymer nanofiller dispersant. Ideally, the uncompounded elastomeric nanocomposite composition contains from 10 to 40 wt % of the graft copolymer nanofiller dispersant.

In addition to the graft copolymer nanofiller dispersant, the elastomeric nanocomposite composition includes at least one additional elastomer component and at least one nanofiller component. Optionally, the elastomeric nanocomposite composition further includes one or more thermoplastic resins. Optionally, the elastomeric nanocomposite composition is compounded and further includes some or all of the following components: processing aids, additional fillers, and curing agents/accelerators.

### Elastomer Component

The elastomer component or parts thereof is halogenated. Preferred halogenated rubbers include bromobutyl rubber, chlorobutyl rubber, brominated copolymers of isobutylene and para-methylstyrene, and mixtures thereof. Halogenated butyl rubber is produced by the halogenation of butyl rubber product. Halogenation can be carried out by any means, and the invention is not herein limited by the halogenation process. Often, the butyl rubber is halogenated in hexane diluent at from 4 to 60° C. using bromine (Bra) or chlorine (Cl₂) as the halogenation agent. The halogenated butyl rubber has a Mooney Viscosity of from 20 to 80 (ML 1+8 at 125° C.), or from 25 to 60. The halogen wt % is from 0.1 to 10 wt % based on the weight of the halogenated butyl rubber, or from 0.5 to 5 wt %. Preferably, the halogen wt % of the halogenated butyl rubber is from 1 to 2.5 wt %.

A suitable commercial halogenated butyl rubber is Bromobutyl 2222 (ExxonMobil Chemical Company). Its Mooney Viscosity is from 27 to 37 (ML 1+8 at 125° C., ASTM 1646, modified), and the bromine content is from 1.8 to 2.2 wt % relative to the Bromobutyl 2222. Further, cure characteristics of Bromobutyl 2222 are as follows: MH is from 28 to 40 dN·m, ML is from 7 to 18 dN·m (ASTM D2084). Another commercial example of the halogenated butyl rubber is Bromobutyl 2255 (ExxonMobil Chemical Company). Its Mooney Viscosity is from 41 to 51 (ML 1+8 at 125° C., ASTM D1646), and the bromine content is from 1.8 to 2.2 wt %. Further, cure characteristics of Bromobutyl 2255 are as follows: MH is from 34 to 48 dN·m, ML is from 11 to 21 dN·m (ASTM D2084).

The elastomer can include a branched or “star-branched” halogenated butyl rubber. The halogenated star-branched butyl rubber (“HSBB”) often includes a composition of a butyl rubber, either halogenated or not, and a polydiene or block copolymer, either halogenated or not. The invention is not limited by the method of forming the HSBB. The polydienes/block copolymer, or branching agents (hereinafter “polydienes”), are typically cationically reactive and are present during the polymerization of the butyl or halogenated butyl rubber, or can be blended with the butyl or halogenated butyl rubber to form the HSBB. The branching agent or polydiene can be any suitable branching agent, and the invention is not limited to the type of polydiene used to make the HSBB.

The HSBB can be a composition of the butyl or halogenated butyl rubber as described above and a copolymer of a polydiene and a partially hydrogenated polydiene selected from the group including styrene, polybutadiene, polyisoprene, polypiperylene, natural rubber, styrene-butadiene rubber, ethylene-propylene diene rubber, styrene-butadiene-styrene and styrene-isoprene-styrene block copolymers. These polydienes are present, based on the monomer wt %, in an amount greater than 0.3 wt %, or from 0.3 to 3 wt %, or from 0.4 to 2.7 wt %.

A commercial example of the HSBB is Bromobutyl 6222 (ExxonMobil Chemical Company), having a Mooney Viscosity (ML 1+8 at 125° C., ASTM D1646) of from 27 to 37, and a bromine content of from 2.2 to 2.6 wt % relative to the HSBB. Further, cure characteristics of Bromobutyl 6222 are as follows: MH is from 24 to 38 dN·m, ML is from 6 to 16 dN·m (ASTM D2084).

The elastomer component can be an isoolefin copolymer comprising a halomethylstyrene derived unit. The halomethylstyrene unit can be an ortho-, meta-, or para-alkyl-substituted styrene unit. The halomethylstyrene derived unit can be a p-halomethylstyrene having at least 80%, more preferably at least 90% by weight of the para-isomer. The “halo” group can be any halogen, desirably chlorine or bromine. The halogenated elastomer may also include functionalized interpolymers wherein at least some of the alkyl substituents groups present in the styrene monomer units contain benzylic halogen or some other functional group described further below. These interpolymers are herein referred to as “isoolefin copolymers comprising a halomethylstyrene derived unit” or simply “isoolefin copolymer”.

The isoolefin of the copolymer can be a C₄ to C₁₂ compound, non-limiting examples of which are compounds such as isobutylene, isobutene, 2-methyl-1-butene, 3-methyl-1-butene, 2-methyl-2-butene, 1-butene, 2-butene, methyl vinyl ether, indene, vinyltrimethylsilane, hexene, and 4-methyl-1-pentene. The copolymer can also further include one or more multiolefin derived units. The multiolefin can be a C₄ to C₁₄ multiolefin such as isoprene, butadiene, 2,3-dimethyl-1,3-butadiene, myrcene, 6,6-dimethyl-fulvene, hexadiene, cyclopentadiene, and piperylene, etc. Desirable styrenic monomer derived units that may comprise the copolymer include styrene, methylstyrene, chlorostyrene, methoxystyrene, indene and indene derivatives, and combinations thereof.

Often, the elastomeric component can be a random elastomeric copolymer of an ethylene derived unit or a C₃ to C₆ α-olefin derived unit and a para-alkylstyrene comonomer, preferably para-methylstyrene containing at least 80%, more preferably at least 90% by weight of the para-isomer and also include functionalized interpolymers wherein at least some of the alkyl substituents groups present in the styrene monomer units contain benzylic halogen or some other functional group. Preferred materials may be characterized as interpolymers containing the following monomer units randomly spaced along the polymer chain:

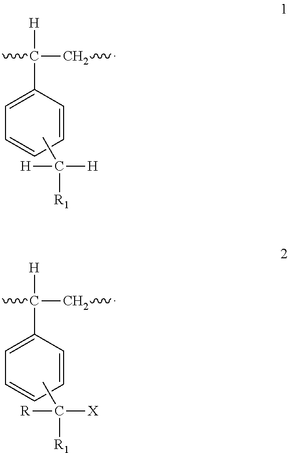

wherein R and R¹ are independently hydrogen, lower alkyl, preferably C₁ to C₇ alkyl and primary or secondary alkyl halides and X is a functional group such as a halogen, triethylammonium, trimethylammonium, or other functional group. Desirable halogens include chlorine, bromine or combinations thereof. Preferably R and R¹ are each hydrogen. The —CRR₁H and —CRR₁X groups can be substituted on the styrene ring in either the ortho, meta, or para positions, preferably para. Up to 60 mole % of the p-substituted styrene present in the interpolymer structure can be the functionalized structure (2) above or from 0.1 to 5 mol %. Alternatively, the amount of functionalized structure (2) is from 0.4 to 1 mol %.

In any embodiment, the functional group X can be a functional group that can be incorporated by nucleophilic substitution of benzylic halogen with other groups such as carboxylic acids; carboxy salts; carboxy esters, amides and imides; hydroxy; alkoxide; phenoxide; thiolate; thioether; xanthate; cyanide; cyanate; amino and mixtures thereof. These functionalized isomonoolefin copolymers, their method of preparation, methods of functionalization, and cure are more particularly disclosed in U.S. Pat. No. 5,162,445.

Most useful of such functionalized materials are elastomeric random interpolymers of isobutylene and alkylstyrene, preferably p-methylstyrene, containing from 0.5 to 20 mole % alkylstyrene, preferably p-methylstyrene, wherein up to 60 mole % of the methyl substituent groups present on the benzyl ring contain a bromine or chlorine atom, preferably a bromine atom (p-bromomethylstyrene), as well as acid or ester functionalized versions thereof wherein the halogen atom has been displaced by maleic anhydride or by acrylic or methacrylic acid functionality. These interpolymers are termed “halogenated poly(isobutylene-co-p-methylstyrene)” or “brominated poly(isobutylene-co-p-methylstyrene)”, and are commercially available under the name EXXPRO™ Elastomers (ExxonMobil Chemical Company, Houston Tex.). It is understood that the use of the terms “halogenated” or “brominated” are not limited to the method of halogenation of the copolymer, but merely descriptive of the copolymer which can include the isobutylene derived units, the p-methylstyrene derived units, and the p-halomethylstyrene derived units.

These functionalized polymers preferably have a substantially homogeneous compositional distribution such that at least 95% by weight of the polymer has a p-alkylstyrene content within 10% of the average p-alkylstyrene content of the polymer. More preferred polymers are also characterized by a narrow molecular weight distribution (M_{w}/Mₙ) of less than 5, more preferably less than 2.5, a preferred viscosity average molecular weight in the range of from 200,000 up to 2,000,000 and a preferred number average molecular weight in the range of from 25,000 to 750,000 as determined by gel permeation chromatography.

The copolymers can be prepared by a slurry polymerization of the monomer mixture using a Lewis acid catalyst, followed by halogenation, preferably bromination, in solution in the presence of halogen and a radical initiator such as heat and/or light and/or a chemical initiator and, optionally, followed by electrophilic substitution of bromine with a different functional derived unit.

Preferred halogenated poly(isobutylene-co-alkylstyrene), preferably halogenated poly(isobutylene-co-p-methylstyrene), are brominated polymers which generally contain from 0.1 to 5 wt % of bromomethyl groups. Alternatively, the amount of bromomethyl groups is from 0.2 to 2.5 wt %. Expressed another way, preferred copolymers contain from 0.05 up to 2.5 mole % of bromine, based on the weight of the polymer, more preferably from 0.1 to 1.25 mole % bromine, and are substantially free of ring halogen or halogen in the polymer backbone chain. In any embodiment, the interpolymer can be a copolymer of C₄ to C₇ isomonoolefin derived units and alkylstyrene, preferably a p-methylstyrene, derived units and preferably a p-halomethylstyrene derived units, wherein the p-halomethylstyrene units are present in the interpolymer from 0.4 to 1 mol % based on the interpolymer. Preferably, the p-halomethylstyrene is p-bromomethylstyrene. The Mooney Viscosity (1+8, 125° C., ASTM D1646, modified) is from 30 to 60 MU.

The elastomer component can include various amounts of one, two, or more different elastomers. For example, compositions described may contain from 5 to 100 phr of halogenated butyl rubber, from 5 to 95 phr of star-branched butyl rubber, from 5 to 95 phr of halogenated star-branched butyl rubber, or from 5 to 95 phr of halogenated poly(isobutylene-co-alkylstyrene), preferably halogenated poly(isobutylene-co-p-methylstyrene). For example, the compositions can contain from 40 to 100 phr of halogenated poly(isobutylene-co-alkylstyrene), preferably halogenated poly(isobutylene-co-p-methylstyrene), and/or from 40 to 100 phr of halogenated star-branched butyl rubber (HSBB).

The elastomer component can include natural rubbers, polyisoprene rubber, styrene butadiene rubber (SBR), polybutadiene rubber, isoprene butadiene rubber (IBR), styrene-isoprene-butadiene rubber (SIBR), ethylene-propylene rubber, ethylene-propylene-diene rubber (EPDM), polysulfide, nitrile rubber, propylene oxide polymers, star-branched butyl rubber and halogenated star-branched butyl rubber, brominated butyl rubber, chlorinated butyl rubber, star-branched polyisobutylene rubber, star-branched brominated butyl (polyisobutylene/isoprene copolymer) rubber; and poly(isobutylene-co-alkylstyrene), preferably isobutylene/methylstyrene copolymers such as isobutylene/meta-bromomethylstyrene, isobutylene/bromomethylstyrene, isobutylene/chloromethylstyrene, halogenated isobutylene cyclopentadiene, and isobutylene/chloromethylstyrene and mixtures thereof.

The elastomer component described herein may further comprise a secondary elastomer component selected from the group consisting of natural rubbers, polyisoprene rubber, styrene butadiene rubber (SBR), polybutadiene rubber, isoprene butadiene rubber (IBR), styrene-isoprene-butadiene rubber (SIBR), ethylene-propylene rubber, ethylene-propylene-diene rubber (EPDM), polysulfide, nitrile rubber, propylene oxide polymers, star-branched butyl rubber and halogenated star-branched butyl rubber, brominated butyl rubber, chlorinated butyl rubber, star-branched polyisobutylene rubber, star-branched brominated butyl (polyisobutylene/isoprene copolymer) rubber; and isobutylene/methylstyrene copolymers such as isobutylene/meta-bromomethylstyrene, isobutylene/bromomethylstyrene, isobutylene/chloromethylstyrene, halogenated isobutylene cyclopentadiene, and isobutylene/chloromethylstyrene and mixtures thereof. Alternatively, the elastomeric composition described herein has less than 10 phr, preferably 0 phr of a secondary elastomer component, preferably 0 phr of the elastomers described above as “secondary elastomer component.”

The elastomer component can include one or more semi-crystalline copolymers (SCC). Semi-crystalline copolymers are described in U.S. Pat. No. 6,326,433. Generally, the SCC is a copolymer of ethylene or propylene derived units and α-olefin derived units, the α-olefin having from 4 to 16 carbon atoms, and can be a copolymer of ethylene derived units and α-olefin derived units, the α-olefin having from 4 to 10 carbon atoms, wherein the SCC has some degree of crystallinity. The SCC can also be a copolymer of a 1-butene derived unit and another α-olefin derived unit, the other α-olefin having from 5 to 16 carbon atoms, wherein the SCC also has some degree of crystallinity. The SCC can also be a copolymer of ethylene and styrene.

The uncompounded elastomeric nanocomposite composition can include up to 99 wt % of the one or more elastomeric components or elastomers (based on the weight of the nanocomposite composition). The uncompounded elastomeric nanocomposite composition can contain from 30 to 99 wt % of the one or more elastomeric components or elastomers. Preferably, the uncompounded elastomeric nanocomposite composition contains from 35 to 90 wt % of the one or more elastomeric components or elastomers. More preferably, the uncompounded elastomeric nanocomposite composition contains from 40 to 85 wt % of the one or more elastomeric components or elastomers. More preferably, the uncompounded elastomeric nanocomposite composition contains from 40 to 80 wt % of the one or more elastomeric components or elastomers. Ideally, the uncompounded elastomeric nanocomposite composition can contain from 40 to 60 wt % of the one or more elastomeric components or elastomers.

### Thermoplastic Resin

The elastomeric nanocomposite composition can include one or more thermoplastic resins. Suitable thermoplastic resins include polyolefins, nylons, and other polymers. Suitable thermoplastic resins can be or include resins containing nitrogen, oxygen, halogen, sulfur or other groups capable of interacting with one or more aromatic functional groups such as a halogen or acidic groups. Suitable thermoplastic resins include polyamides, polyimides, polycarbonates, polyesters, polysulfones, polylactones, polyacetals, acrylonitrile-butadiene-styrene resins (ABS), polyphenyleneoxide (PPO), polyphenylene sulfide (PPS), polystyrene, styrene-acrylonitrile resins (SAN), styrene maleic anhydride resins (SMA), aromatic polyketones (PEEK, PED, and PEKK) and mixtures thereof.

The elastomeric nanocomposite composition can include any of the thermoplastic resins (also referred to as a thermoplastic or a thermoplastic polymer) described above that are formed into dynamically vulcanized alloys. The term “dynamic vulcanization” is used herein to connote a vulcanization process in which the engineering resin and a vulcanizable elastomer are vulcanized under conditions of high shear. As a result, the vulcanizable elastomer is simultaneously crosslinked and dispersed as fine particles of a “micro gel” within the engineering resin matrix. A further description of suitable thermoplastic resins and dynamically vulcanized alloys is available in U.S. Pat. No. 7,923,491, which is hereby incorporated by reference.

The uncompounded elastomeric nanocomposite composition can include up to 49 wt % thermoplastic resin (based on the weight of the nanocomposite composition). The uncompounded elastomeric nanocomposite composition can contain from 0.5 to 45 wt % thermoplastic resin. Preferably, the uncompounded elastomeric nanocomposite composition contains from 2 to 35 wt % thermoplastic resin. More preferably, the uncompounded elastomeric nanocomposite composition contains from 5 to 30 wt % thermoplastic resin. Ideally, the uncompounded elastomeric nanocomposite composition contains from 10 to 25 wt % thermoplastic resin.

### Nanofillers

The elastomeric nanocomposite composition typically includes nanoparticles of graphite (preferably graphene). The nanoparticles have at least one dimension (length, width or thickness) of less than 100 nanometers. Alternately two dimensions (length, width or thickness) are less than 100 nanometers, alternately all three dimensions (length, width and thickness) are less than 100 nanometers. Preferably, the nanoparticle is a sheet having a thickness of less than 100 nanometers and a length and or width that is at least 10 times greater than the thickness (preferably 20 to 500 times, preferably 30 to 500 times the thickness). Alternatively, the graphite has a shape that is needle-like or plate-like, with an aspect ratio greater than 1.2 (preferably greater than 2, preferably greater than 3, preferably greater than 5, preferably greater than 10, preferably greater than 20), where the aspect ratio is the ratio of the longest dimension to the shortest dimension (length, width, and thickness) of the particles, on average. Alternatively, the graphite is pulverized. Useful graphites may have a specific surface area of 10 to 2000 m²/g, preferably from 50 to 1000 m²/g, preferably from 100 to 900 m²/g.

Preferably, the uncompounded nanocomposite contains 0.01 wt % to 15.0 wt % graphite (preferably graphene) nanoparticles (i.e., based on the total weight of the nanofiller dispersant, elastomer component, and nanofiller). More preferably, the uncompounded nanocomposite contains 0.05 wt % to about 10.0 wt % graphite (preferably graphene) nanoparticles. More preferably, the uncompounded nanocomposite contains from about 0.1 wt % to about 10.0 wt %; from about 0.5 wt % to about 10.0 wt %; from about 1.0 wt % to about 10.0 wt % graphite (preferably graphene) nanoparticles. Ideally, the uncompounded nanocomposite contains from a low of about 0.05 wt %, 0.5 wt % or 1.2 wt % to a high of about 5.0 wt %, 7.5 wt %, or 10.0 wt % graphite (preferably graphene) nanoparticles.

Preferably, the graphite (preferably graphene) has up to 50 wt % present in the beta form, typically form 5 to 30 wt %. Alternatively, the graphite (preferably graphene) is present in the alpha form, having typically less than 1 wt % beta form, preferably 0 wt % beta form.

The graphite is preferably in the form of nano graphene platelets (NGPs) obtained through rapid expansion of graphite. Expanded graphite can typically be made by immersing natural flake graphite in a bath of acid (such as sulphuric acid, nitric acid, acetic acid, and combinations thereof, or the combination of chromic acid, then concentrated sulfuric acid), which forces the crystal lattice planes apart, thus expanding the graphite.

Preferably, the expandable graphite may have one or more of the following properties (before expansion): a) particle size of 32 to 200 mesh, (alternately a median particle diameter of 0.1 to 500 microns (alternately 0.5 to 350 microns, alternately 1 to 100 microns)), and/or b) expansion ratio of up to 350 cc/g, and/or c) a pH of 2 to 11, (preferably 4 to 7.5, preferably 6 to 7.5). Expandable graphite can be purchased from GRAFTech International or Asbury Carbons, Anthracite Industries, among others. Particularly useful expandable graphite includes GRAFGUARD™ Expandable Graphite Flakes. Expanded graphite can be further milled for the production of NGPs, as described in U.S. Pat. No. 7,550,529, with a thickness ranging from 1 to 20 nanometers and width ranging from 1 to 50 microns. Particularly useful NGPs, or short stacks of graphene sheets, include grades H, M, and C of xGnP™ NGPs, commercially available from XG Sciences, Inc., and N008-N, N008-P, and N006-P NGP materials, commercially available from Angstron Materials, Inc.

Preferably, the expandable graphite has an onset temperature (temperature at which it begins to expand) of at least 160° C. or more, alternately 200° C. or more, alternately 400° C. or more, alternately 600° C. or more, alternately 750° C. or more, alternately 1000° C. or more. Preferably the expandable graphite has an expansion ratio of at least 50:1 cc/g, preferably at least 100:1 cc/g, preferably at least 200:1 cc/g, preferably at least 250:1 cc/g at 600° C. Alternatively, the expandable graphite has an expansion ratio of at least 50:1 cc/g, preferably at least 100:1 cc/g, preferably at least 200:1 cc/g, preferably at least 250:1 cc/g at 150° C. The graphite may be expanded before it is combined with the other blend components or it may be expanded while blending with other blend components. Often, the graphite is not expanded (or expandable) after formation into an article (such as an air barrier, or a tire innerliner).

Preferably, the graphite is or comprises graphene. Graphene is a one-atom-thick planar sheet of sp2-bonded carbon atoms that are densely packed in a honeycomb crystal lattice. The carbon-carbon bond length in graphene is approximately 1.42 angstroms. Graphene is the basic structural element of graphitic materials including graphite, as graphite can be considered to be many layers of graphene. Graphene can be prepared by micromechanical cleavage of graphite (e.g., removing flakes of graphene from graphite) or by exfoliation of intercalated graphitic compounds. Likewise, graphene fragments can be prepared through chemical modification of graphite. First, microcrystalline graphite is treated with a strongly acidic mixture of sulfuric acid and nitric acid. Then the material is oxidized and exfoliated resulting in small graphene plates with carboxyl groups at their edges. These are converted to acid chloride groups by treatment with thionyl chloride; next, they are converted to the corresponding graphene amide via treatment with octadecylamine. The resulting material (circular graphene layers of 5.3 angstrom thickness) is soluble in tetrahydrofuran, tetrachloromethane, and dichloroethane. (see Niyogi, et al. Solution Properties of Graphite and Graphene, J. Am. Chem. Soc., 128(24), pp. 7720-7721 (2006).) Alternatively, the graphite is present in the elastomer composition as dispersed nanosheets having a thickness of less than 100 nanometers, preferably less than 50 nanometers, preferably less than 30 nanometers.

### Additional Fillers

In addition to the aforementioned nanofillers, the compounded elastomeric nanocomposite composition can be compounded and include one or more non-exfoliating fillers such as calcium carbonate, clay, mica, silica and silicates, talc, titanium dioxide, starch, and other organic fillers such as wood flour, and carbon black. These filler components are typically present at a level of from 10 to 200 phr of the compounded composition, more preferably from 40 to 140 phr. Preferably, two or more carbon blacks are used in combination, for example, Regal 85 is a carbon black that has multiple particle sizes, rather than just one. Combinations also include those where the carbon blacks have different surface areas. Likewise, two different blacks which have been treated differently may also be used. For example, a carbon black that has been chemically treated can be combined with a carbon black that has not.

The compounded elastomeric nanocomposite can include carbon black having a surface area of less than 35 m²/g and a dibutylphthalate oil absorption of less than 100 cm³/100 g. Carbon blacks can include, but are not limited to N660, N762, N774, N907, N990, Regal 85, and Regal 90. Table 1 shows properties of useful carbon blacks.

TABLE 1

| Grade | SA (m²/g) | DBP Absorption (cm³/100 g) |
|---|---|---|
| N660 | 34 | 90 |
| N754 | 25 | 58 |
| N762 | 26 | 64 |
| N774 | 28 | 70 |
| N787 | 30 | 80 |
| N907 | 10 | 38 |
| N990 | 7 | 42 |
| N991 | 10 | 38 |
| Regal 85 | 23 | 33 |
| Regal 90 | 23 | 32 |
| ARO 60 | 23 | 58 |
| SL 90 | 25 | 58 |

The carbon black having a surface area of less than 35 m2/g and a dibutylphthalate oil absorption of less than 100 cm³/100 g is typically present in the nanocomposite at a level of from 10 to 200 phr, preferably 20 to 180 phr, more preferably 30 to 160 phr, and more preferably 40 to 140 phr.

### Curing Agents, Processing Aids, and Accelerators

The compounded elastomeric nanocomposite composition can include one or more other components and cure additives customarily used in rubber mixes, such as pigments, accelerators, cross-linking and curing materials, antioxidants, antiozonants, and fillers. Preferably, processing aids (resins) such as naphthenic, aromatic or paraffinic extender oils can be present from 1 to 30 phr of the compounded composition. Alternatively, naphthenic, aliphatic, paraffinic and other aromatic resins and oils are substantially absent from the composition. By “substantially absent,” it is meant that naphthenic, aliphatic, paraffinic, and other aromatic resins are present, if at all, to an extent no greater than 2 phr in the composition.

Generally, polymer compositions, e.g., those used to produce tires, are crosslinked. It is known that the physical properties, performance characteristics, and durability of vulcanized rubber compounds are directly related to the number (crosslink density) and type of crosslinks formed during the vulcanization reaction. (See, e.g., Helt et al., The Post Vulcanization Stabilization for NR, Rubber World 18-23 (1991)). Cross-linking and curing agents include sulfur, zinc oxide, and organic fatty acids. Peroxide cure systems may also be used. Generally, polymer compositions can be crosslinked by adding curative molecules, for example sulfur, metal oxides (i.e., zinc oxide), organometallic compounds, radical initiators, etc., followed by heating. In particular, the following are common curatives that will function in the present invention: ZnO, CaO, MgO, Al₂O₃, CrO₃, FeO, Fe₂O₃, and NiO. These metal oxides can be used in conjunction with the corresponding metal stearate complex (e.g., Zn(Stearate)₂, Ca(Stearate)₂, Mg(Stearate)₂, and Al(Stearate)₃), or with stearic acid, and either a sulfur compound or an alkylperoxide compound. (See also, Formulation Design and Curing Characteristics of NBR Mixes for Seals, Rubber World 25-30 (1993)). This method can be accelerated and is often used for the vulcanization of elastomer compositions.

Accelerators include amines, guanidines, thioureas, thiazoles, thiurams, sulfenamides, sulfenimides, thiocarbamates, xanthates, and the like. Acceleration of the cure process can be accomplished by adding to the composition an amount of the accelerant. The mechanism for accelerated vulcanization of natural rubber involves complex interactions between the curative, accelerator, activators and polymers. Ideally, all of the available curative is consumed in the formation of effective crosslinks which join together two polymer chains and enhance the overall strength of the polymer matrix. Numerous accelerators are known in the art and include, but are not limited to, the following: stearic acid, diphenyl guanidine (DPG), tetramethylthiuram disulfide (TMTD), 4,4′-dithiodimorpholine (DTDM), alkyl disulfides, such as tetrabutylthiuram disulfide (TBTD) and 2,2′-benzothiazyl disulfide (MBTS), hexamethylene-1,6-bisthiosulfate disodium salt dihydrate, 2-(morpholinothio) benzothiazole (MBS or MOR), compositions of 90% MOR and 10% MBTS (MOR 90), N-tertiarybutyl-2-benzothiazole sulfenamide (TBBS), N-oxydiethylene thiocarbamyl-N-oxydiethylene sulfonamide (OTOS), zinc 2-ethyl hexanoate (ZEH), and N,N′-diethyl thiourea.

Preferably, at least one curing agent is present from 0.2 to 15 phr of the compounded composition, or from 0.5 to 10 phr. Curing agents include those components described above that facilitate or influence the cure of elastomers, such as metals, accelerators, sulfur, peroxides, and other agents common in the art, as described above.

### Processing

Mixing of the components to form the elastomeric nanocomposite composition and/or compounding of the elastomeric nanocomposite composition can be carried out by combining the components in any suitable internal mixing device such as a Banbury™ mixer, BRABENDER™ mixer, or extruder (e.g., a single screw extruder or twin screw extruder). Mixing can be performed at temperatures up to the melting point of the elastomers and/or rubbers used in the composition at a rate sufficient to allow the graphite and/or graphene to become uniformly dispersed within the polymer to form the nanocomposite.

Suitable mixing rates can range from about 10 RPM to about 8,500 RPM. Preferably, the mixing rate can range from a low of about 10 RPM, 30 RPM, or 50 RPM to a high of about 500 RPM, 2,500 RPM, or 5,000 RPM. More preferably, the mixing rate can range from a low of about 10 RPM, 30 RPM, or 50 RPM to a high of about 200 RPM, 500 RPM, or 1,000 RPM.

The mixing temperature can range from about 40° C. to about 340° C., or from about 80° C. to about 300° C., or from about 50° C. to about 170° C. Preferably, the mixing temperature can range from a low of about 30° C., 40° C., or 50° C. to a high of about 70° C., 170° C., or 340° C. Alternatively, the mixing temperature can range from a low of about 80° C., 90° C., or 100° C. to a high of about 120° C., 250° C., or 340° C. Yet alternatively, the mixing temperature can range from a low of about 85° C., 100° C., or 115° C. to a high of about 270° C., 300° C., or 340° C.

Often, 70% to 100% of the one or more elastomer components along with the one or more graft copolymer nanofiller dispersants can be mixed at a rate noted above for 20 to 90 seconds, or until the temperature reaches from 40° C. to 60° C. Then, 75% to 100% of the nanofiller, and the remaining amount of elastomer and/or nanofiller dispersant, if any, can be added to the mixer, and mixing can continue until the temperature reaches from 90° C. to 150° C. Next, any remaining nanofiller and/or additional fillers can be added, as well as processing oil, and mixing can continue until the temperature reaches from 140° C. to 190° C. The finished mixture can then be finished by sheeting on an open mill and allowed to cool to from 60° C. to 100° C. when the curatives are added.

Alternatively, 75% to 100% of the one or more graft copolymer nanofiller dispersants and 75% to 100% of the nanofiller can be mixed, preferably via solution blending. Preferably, the mixing is performed at a temperature ranging from 50° C. to 170° C., more preferably from 90° C. to 150° C. The resulting mixture can be mixed with 70% to 100% of the one or more elastomer components at a rate noted above for 20 to 90 seconds, or until the temperature reaches from 40° C. to 60° C. Then, the remaining amount of elastomer and/or nanofiller dispersant, if any, can be added to the mixer, and mixing can continue until the temperature reaches from 90° C. to 150° C. Next, any remaining nanofiller and/or additional fillers can be added, as well as processing oil, and mixing can continue until the temperature reaches from 140° C. to 190° C. The finished mixture can then be finished by sheeting on an open mill and allowed to cool to from 60° C. to 100° C. when the curatives are added.

### INDUSTRIAL APPLICABILITY

The composition described herein may be incorporated into articles, such as films, sheets, molded parts and the like. Specifically the composition described herein may be formed into tires, tires parts (such as sidewalls, treads, tread cap, innertubes, innerliners, apex, chafer, wirecoat, and ply coat), tubes, pipes, barrier films/membranes, or any other application where air impermeability would be advantageous.

Preferably, articles formed from the elastomeric compositions described herein have a permeability of 180 mm-cc/M²-day or less, preferably 160 mm-cc/M²-day or less, preferably 140 mm-cc/M²-day or less, preferably 120 mm-cc/M²-day or less, preferably 100 mm-cc/M²-day or less, as determined on a MOCON OX-TRAN 2/61 permeability tester at 40° C. as described below. Preferably, elastomeric nanocomposites formed in accordance with the invention have a permeability of at least 10% lower, more preferably at least 20% lower, more preferably at least 30% lower, and ideally at least 50% lower than the elastomer component.

### EXAMPLES

The foregoing discussion can be further described with reference to the following non-limiting examples.

### Representative Synthesis and Properties of PPE-g-PIB Graft Copolymer

A typical synthetic procedure is described here. Under nitrogen protection, a 1 L reaction vessel equipped with overhead mechanical stirrer and condenser was charged with 60 g PPE (Sigma-Aldrich, Mn=15K determined by GPC referenced to polystyrene), 20 g VTPIB (Glissopal™ 1000 available from BASF, Mn=1K), a 0.08 g stabilizer package comprising a mixture of 50 wt % Irganox™ 1076 (Sigma-Aldrich) and 50 wt % Irgafos™ 168 (Sigma-Aldrich), and 700 mL anhydrous 1,2-dichlorobenzene (o-DCB) (Sigma-Aldrich). The mixture was heated to 120° C. to fully dissolve the reactants, after which a methansulfonic acid (MSA) catalyst (Sigma-Aldrich) was slowly added to the reaction mixture. The temperature of the reaction mixture was then increased and the reaction was allowed to proceed at reflux under nitrogen protection for four hours. The reaction mixture was precipitated in 3.5 L of methanol. The resulting product was filtered and washed with fresh methanol and dried in a vacuum oven at 60° C. until reaching constant weight.

The PPE-PIB graft copolymer was characterized by proton nuclear magnetic resonance (¹H NMR). NMR spectra were acquired using a 600 MHz spectrometer obtained from Bruker Corporation, with 1,1,2,2-tetrachloroethane-d₂ (TCE-d₂) used as the solvent. The acquired NMR spectra were compared to those of the starting materials to determine that 89% of the PIB was grafted to the PPE backbone.

Solution Blending of PPE-PIB Graft Copolymer with Nano Graphene Platelets

A solution blend of the synthesized PPE-PIB graft copolymer with nano graphene platelets was prepared in accordance with the following procedure. 10 g of grade C xGnP™ nano graphene platelets having an average surface area of 500 m²/g and a density of from 2-2.25 g/cc, commercially available from XG Sciences, Inc., was first dissolved in 500 mL of o-DCB under nitrogen protection in a 1 L 3-neck round bottom flask equipped with a condenser at 120° C. Afterward, 40 g of PPE-PIB graft copolymer was added and the components were mixed under reflux for four hours. Next, the mixture was precipitated in 1 L of isopropanol while still warm. The resulting product was filtered and washed with fresh isopropanol and dried in a vacuum oven at 60° C.

### Preparation of Samples and Oxygen Permeability Characterization

Five samples (samples 1-5) were prepared for oxygen permeability testing. Sample 1 (comparative) contained 36 g of a neat Bromobutyl 2222 grade BIIR compound, sample 2 (comparative) contained 36 g of a blend comprising Bromobutyl 2222 grade BIIR compound copolymer at a concentration of 75 wt % and PPE at a concentration of 25 wt %, and each of samples 3-5 (inventive) contained 36 g of a BIIR based nanocomposite comprising varying concentrations (shown in Table 2) of the prepared solution blend of PPE-PIB graft copolymer with NGPs.

Each of samples 1-5 was compounded by charging the material (36 g) into a BRABENDER™ mixer at 135° C. and 60 RPM. After 1 minute, 20 g of N660 Carbon Black (CB) fillers were added. The mixing was then continued for another 6 minutes for a total mix time of 7 minutes. The material was then removed, cut up, and fed back into the BRABENDER™ mixer at 45° C. and 40 RPM. After 1 minute, 0.33 g MBTS (Mercaptobenzothiazole disulfide), 0.33 g zinc oxide, and 0.33 g stearic acid curatives were added. The mixing was then continued for another 3 minutes for a total mix time of 4 minutes.

The compounded materials were pressed in between Teflon™ sheets and molded/cured at 170° C. for 15 minutes. The resulting cure pads were then used for property measurements and for dispersion characterization. The oxygen permeability values were measured using a MOCON OX-TRAN 2/61 permeability tester at 40° C., 0% RH, and 760 mm Hg. The results of the oxygen permeability testing, along with the compositional makeup of each sample (given in terms of the uncompounded sample), are summarized in Table 2. The change in permeability values reported in Table 2 were calculated relative to the permeability of sample 1.

TABLE 2

| | | | | | | Change |
|---|---|---|---|---|---|---|
| | | | PPE- | | Perme- | in |
| | BIIR | PPE | PIB | NGP | ability | Perme- |
| | (wt | (wt | (wt | (wt | (mm-cc)/ | ability |
| Samples | %) | %) | %) | %) | (M²-day) | (%) |
| 1 (COMPAR- | 100 | 0 | 0 | 0 | 166 | — |
| ATIVE) | | | | | | |
| 2 (COMPAR- | 75 | 25 | 0 | 0 | 230 | +38.6 |
| ATIVE) | | | | | | |
| 3 | 95 | 0 | 4 | 1 | 175 | +5.42% |
| 4 | 75 | 0 | 20 | 5 | 159 | −4.22 |
| 5 | 50 | 0 | 40 | 10 | 67 | −59.6 |

PPE has a higher permeability relative to BIIR. Accordingly, as shown in Table 2, the addition of PPE to BIIR (sample 2) resulted in an undesirable 38.6% increase in permeability relative to the neat BIIR compound of sample 1. Likewise, although the addition of NGPs would be expected to lower the permeability of a BIIR based compound, sample 3, having an NPG loading of 1 wt % and a PPE-PIB copolymer content of 4 wt %, exhibited an increase in permeability of 5.42%. This result suggests that at low NGP loading the permeability lowering effect of the NGPs is not large enough to offset the permeability increase due to the addition of the PPE-PIB copolymer. In contrast, despite having an even higher PPE-PIB copolymer content of 40 wt %, sample 5 (having a 10 wt % NGP loading) exhibited a significant permeability decrease of 59.6% relative to the neat BIIR compound.

### Additional Test Methods

Molecular weights (number average molecular weight (Mn) and weight average molecular weight (Mw) are determined using a Polymer Laboratories Model 220 high temperature GPC-SEC equipped with on-line differential refractive index (DRI), light scattering (LS), and viscometer (VIS) detectors (so called GPC-3D, Gel Permeation Chromatography-3 Detectors). It uses three Polymer Laboratories PLgel 10 m Mixed-B columns for separation using a flow rate of 0.54 ml/min and a nominal injection volume of 300 μL. The detectors and columns are contained in an oven maintained at 135° C. The stream emerging from the size exclusion chromatography (SEC) columns is directed into the miniDAWN (Wyatt Technology, Inc.) optical flow cell and then into the DRI detector. The DRI detector is an integral part of the Polymer Laboratories SEC. The viscometer is inside the SEC oven, positioned after the DRI detector. The details of these detectors, as well as their calibrations referenced to polystyrene, have been described by, for example, T. Sun, P. Brant, R. R. Chance, and W. W. Graessley, in 34(19) MACROMOLECULES, 6812-6820, (2001).

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the invention have been illustrated and described, various modifications can be made without departing from the spirit and scope of the invention. Accordingly, it is not intended that the invention be limited thereby. For example, the compositions described herein may be free of any component, or composition not expressly recited or disclosed herein. Any method may lack any step not recited or disclosed herein. Likewise, the term “comprising” is considered synonymous with the term “including.” And whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

1. An elastomeric nanocomposite composition comprising:
(a) a nanofiller dispersant comprising the reaction product of
(i) at least one polyaliphatic hydrocarbon; and
(ii) at least one polyaromatic hydrocarbon,
(b) at least one halogenated elastomer component comprising units derived from isoolefins having from 4 to 7 carbons; and
(c) at least one nanofiller,
wherein the nanofiller dispersant is present from 0.5 wt % to 49 wt % based on the total weight of the nanofiller dispersant, the elastomer component, and the nanofiller,
and wherein the nanofiller is present at from 0.01 wt % to 15.0 wt % based on the total weight of the nanofiller dispersant, the elastomer component, and the nanofiller.

2. The composition of claim 1, wherein the polyaliphatic hydrocarbon comprises polyisobutylene, wherein the polyisobutylene is vinyl/vinylidene terminated and has a weight average molecular weight of at least 300 g/mole.

3. The composition of claim 1, wherein the polyaromatic hydrocarbon has at least one phenylene in the polymer backbone.

4. The composition of claim 1, wherein the reaction of the polyaliphatic hydrocarbon with the polyaromatic hydrocarbon is facilitated with a Friedel-Crafts catalyst at a temperature within the range from 80° C. to 200° C.

5. The composition of claim 1, wherein the nanofiller dispersant comprises a graft copolymer comprising polyaliphatic and polyaromatic hydrocarbon components, wherein the polyaromatic hydrocarbon component is a polymer comprising heteroatoms or heteroatom containing moieties in its backbone and phenyl or substituted phenyl groups, the polyaliphatic hydrocarbon component covalently bound to the polyaromatic hydrocarbon component.

6. The composition of claim 5, wherein the molar ratio of the polyaliphatic hydrocarbon component to the polyaromatic hydrocarbon component in the graft copolymer is within a range of from 99:1 to 1:99.

7. The composition of claim 5, wherein the graft copolymer has the structure: 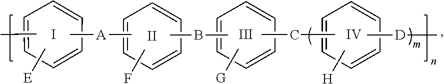
wherein each I, II, III, and IV are, independently, 1,2-phenyl, 1,3-phenyl or 1,4-phenyl, any of which may be substituted with one or more electron-donating substituents;
at least one of A, B, C, and D are, independently, an oxygen, nitrogen, sulfur, or phosphorous atom, or a moiety comprising oxygen, nitrogen, sulfur, phosphorous, or a combination thereof;
at least one of E, F, G, and H are one, two or three polyaliphatic hydrocarbon components bound to I, II, III, and IV, respectively, wherein each of the polyaliphatic hydrocarbon components has a weight average molecular weight of at least 300 g/mole; and
m is an integer within the range from 1 to 10, and n is an integer within the range from 10 to 500.

8. The composition of claim 7, wherein the electron-donating substituents are selected from the group consisting of C₁ to C₁₀ alkyls, C₁ to C₁₀ alkoxys, C₁ to C₁₀ mercaptans, chlorine, bromine, iodine, hydroxyl, and combinations thereof.

9. The composition of claim 7, wherein the A, B, C, and D substituents are selected from the group consisting of C₁ to C₁₀ carboxy-containing moieties, C₁ to C₁₀ imido-containing moieties, C₁ to C₁₀ sulfido-containing moieties, sulfur, sulfide, carboxy, carboxylate, imido, nitrogen, and combinations thereof.

10. The composition of claim 7, wherein the A, B, C, and D substituents are selected from the group consisting of —CH₂—NH—CO—(CH₂)₄—CH₂—, —OCOO—, CO—, pyromellitic diimidos, —SO₂—, sulfur, oxygen, nitrogen, phosphorous, and combinations thereof.

11. The composition of claim 7, wherein the A, B, C, and D substituents are oxygen, and I, II, III, and IV are 2,6-dimethyl-1,4-phenyl, and m is 1.

12. The composition of claim 1, wherein the nanofiller is selected from the group consisting of graphite, expanded graphite, nano graphene platelets (NGPs), and graphene, and mixtures and combinations thereof.

13. The composition of claim 1, wherein the elastomer component is selected from the group consisting of chlorinated poly(isobutylene-co-isoprene) (CIIR) and brominated poly(isobutylene-co-isoprene) (BIIR), and mixtures and combinations thereof.

14. The composition of claim 13, wherein the oxygen permeability of the elastomeric nanocomposite at 40° C. is at least 50% lower than the permeability of the elastomer component.

15. The composition of claim 1, further comprising at least one component selected from the group consisting of additional fillers, processing oils, and cure additives, wherein the cure additives are selected from the group consisting of metal oxides, organic acids, and alkyl disulfides, and mixtures and combinations thereof.

16. An innerliner for a tire comprising the composition of claim 1.

17. A method of producing an elastomeric nanocomposite composition, the method comprising:
(a) combining at least one polyaliphatic hydrocarbon and at least one polyaromatic hydrocarbon with a Friedel-Crafts catalyst at a temperature within the range from 80° C. to 200° C. to produce a nanofiller dispersant;
(b) mixing the nanofiller dispersant with (i) at least one halogenated elastomer component comprising units derived from isoolefins having from 4 to 7 carbons and (ii) at least one nanofiller
wherein the nanocomposite composition comprises from 0.01 wt % to 15.0 wt % of the nanofiller and from 0.5 wt % to 49 wt % of the nanofiller dispersant, wherein the weight percentages are based on the total weight of the nanofiller dispersant, the elastomer component, and the nanofiller.

18. The method of claim 17, wherein the polyaliphatic hydrocarbon comprises polyisobutylene, wherein the polyisobutylene is vinyl/vinylidene terminated and has a weight average molecular weight of at least 300 g/mole.

19. The method of claim 18, wherein the vinyl/vinylidene terminated polyisobutylene has a weight average molecular weight (M_{w}) within a range from 300 g/mole to 300,000 g/mole.

20. The method of claim 17, wherein the polyaromatic hydrocarbon has a weight average molecular weight (M_{w}) within a range from 5,000 g/mole to 80,000 g/mole.

21. The method of claim 17, wherein the polyaromatic hydrocarbon has at least one phenylene in the polymer backbone.

22. The method of claim 17, wherein the nanofiller is selected from the group consisting of graphite, expanded graphite, nano graphene platelets (NGPs), and graphene, and mixtures and combinations thereof.

23. The method of claim 17, wherein the halogenated elastomer component is selected from the group consisting of chlorinated poly(isobutylene-co-isoprene) (CIIR) and brominated poly(isobutylene-co-isoprene) (BIIR), and mixtures and combinations thereof.

24. The method of claim 23, wherein the oxygen permeability of the elastomeric nanocomposite at 40° C. is at least 50% lower than the permeability of the elastomer component.

25. The use of a composition comprising a graft copolymer as a nanofiller dispersant in an elastomeric nanocomposite, wherein the graft comprises polyaliphatic and polyaromatic hydrocarbon components, wherein the polyaromatic hydrocarbon component is a polymer comprising heteroatoms or heteroatom containing moieties in its backbone and phenyl or substituted phenyl groups, the polyaliphatic component covalently bound to the polyaromatic hydrocarbon component.
